(19) United States
(12) Patent Application Publication
(10) Pub. No.: US 2009/0007877 A1
(43) Pub. Date: Jan. 8, 2009

(54) Systems and Methods to Control Torsional Vibration in an Internal Combustion Engine with Cylinder Deactivation

(76) Inventor: Gregory L. Raiford, Walled Lake, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/773,823

(22) Filed: Jul. 5, 2007

(51) Int. Cl. F16F 15/02; F02B 75/06

(52) U.S. Cl. 123/192.1; 73/700

(57) ABSTRACT

The present disclosure utilizes deactivated cylinders in a variable displacement engine to control the torsional vibration of a crankshaft. In a deactivated mode, deactivated cylinders are compressed and expanded by a reciprocating piston, but they are doing no net work and still causing an oscillating torque on the crankshaft. The present disclosure utilizes this oscillating torque to counter torque from the active cylinders. This is done through controlling the gas pressure in the deactivated cylinders by using intake and exhaust values to equalize the pressure between the cylinder and ports. The optimum gas pressure in deactivated cylinders to minimize total torque fluctuations is approximately one-half that of the active cylinders. A closed control loop adjusts gas pressure in the deactivated cylinders to cancel out torque from the active cylinders.

### FIELD OF THE DISCLOSURE

The present disclosure relates generally to internal combustion engines in automobiles configured wife cylinder deactivation. More specifically, the present disclosure provides systems and methods to reduce torsional vibrations due to cylinder deactivation by controlling the pressure in deactivated cylinders to minimize torsional vibrations.

### BACKGROUND OF THE DISCLOSURE

Variable displacement systems (VDS) work by selectively taming off cylinders in an engine, such as a bank of cylinders in a V-type engine. An example of a variable displacement system is the Multi-Displacement System (MDS) available from DaimlerChrysler Corp. of Auburn Hills, Mich. For example, a variable displacement system can deactivate two, three, or four cylinders in a V4, V6, or V8 engine, respectively, when the torque demand of the engine is relatively low, VDS effectively provide two engines in one: a large displacement engine for when power demand, is high, such as brisk acceleration or towing, and a smaller, more fuel efficient engine for when power demand is low, such as cruising on a highway. In the more, fuel efficient mode of operation, the engine will fire only some of its cylinders, while the spark and the valve train operation will be disabled in the other cylinders. Advantageously, such variable displacement systems improve fuel economy in modern automobiles.

Disadvantageously, engine vibrations can be more unpleasant when operating in the more fuel efficient mode leading to objectionable noise, vibration, and harshness (NVH) due to torsional vibrations. This is because the engine is providing the same output with fewer cylinders firing, the torque fluctuation from, each firing event is greater, and the frequency of the firing is lower, which makes the vibration more difficult to control with traditional vibration absorbers. Existing methods to control torsional vibrations due to cylinder deactivation include utilizing two mass flywheels or dampers tuned to a specific frequency. However, these methods are complex and require additional costly parts to be used.

### BRIEF SUMMARY OF THE DISCLOSURE

In various exemplary embodiments, the present disclosure utilizes deactivated cylinders is a variable displacement engine to control the torsional vibration of a crankshaft. In a deactivated mode, deactivated cylinders are compressed and expanded by a reciprocating piston, but they are doing no net work and still causing an oscillating torque on the crankshaft. The present disclosure utilizes this oscillating torque to counter torque from the active cylinders. This is done through controlling the gas pressure in the deactivated cylinders by using intake and exhaust values to equalize the pressure between the cylinder and ports to achieve an optimum gas pressure in the deactivated cylinders. For example, the optimum gas pressure in deactivated cylinders to minimize total torque fluctuations is approximately one-half that of the active cylinders for a V8 variable displacement engine. The optimum gas pressure for other types of engines can be determined through measurement or simulations.

The present disclosure utilizes an Electronic Control Unit (ECU) or the like in combination with pressure sensors in all cylinders. The pressure sensors report pressure measurements, and the ECU calculates an optimal pressure for the deactivated cylinders based on averages from, the active cylinders. Accordingly, the ECU can control intake and exhaust valves in the deactivated cylinders to equalize the pressure to the calculated optimal level. The present disclosure utilizes an engine's management system to operate a control loop to control pressure in deactivated cylinders to minimize the overall torsional vibrations. Advantageously, the systems and methods of the present disclosure, are effective, at all engine speeds and can be turned on/off without affecting engine operation. Additionally, the present disclosure eliminates the need for flywheels or dampers to control vibrations, and provides better durability and packaging issues.

In an exemplary embodiment of the present disclosure, a method to control torsional vibrations due to cylinder deactivation, includes measuring gas pressure in an active and a deactivated cylinder, determining a target pressure for the deactivated cylinder responsive to the measured gas pressure in the active cylinder, and adjusting a phase on a pressure control valve of the deactivated cylinder responsive to a difference between the measured gas pressure in the deactivated cylinder and the determined target pressure for the deactivated cylinder. The measuring step is performed by a cylinder pressure sensor. Optionally, the target pressure includes a value that is approximately one-half of the measured gas pressure in the active cylinder. The target pressure includes a value that is determined through one of measurement and simulation. The adjusting step includes if the measured gas pressure in the deactivated cylinder is higher than the target pressure, moving the pressure control valve phase away from bottom dead center, and if the measured gas pressure in the deactivate cylinder is lower than the target pressure, moving the pressure control valve phase closer to bottom dead center. The pressure control valves include one of an intake valve, an exhaust valve, and combinations thereof. The method to control torsional vibrations further includes opening the pressure control valve when a piston is at bottom dead center, wherein the adjusting phase step is operable to adjust the opening of the pressure control valve in order to equalize gas pressure in the deactivated cylinder. The target pressure provides torque oscillations from the deactivated cylinder that is out of phase with the torque oscillations from the active cylinder; and the torque oscillations from the deactivated cylinder and the torque oscillations from, the active cylinder cancel each other out thereby reducing torsional vibrations. Optionally, the adjusting step and determining steps are performed by an electronic control unit, the measuring step is performed by a cylinder pressure sensor, the cylinder pressure sensor communicates measured gas pressure to the electronic control unit, and the electronic control unit operates the pressure control valve to achieve the target pressure in the deactivated cylinder.

In another exemplary embodiment of the present disclosure, a torsional vibration control system for an engine configured with cylinder deactivation includes a plurality of cylinders each including a cylinder pressure sensor and a pressure control valve, wherein the cylinder pressure sensor is configured to measure gas pressure in the cylinder, and an electronic control unit in communication with each of the cylinder pressure sensors in the plurality of cylinders. The electronic control unit is configured to receive gas pressure measurements for each of the plurality of cylinders, determine a maximum gas pressure for each active cylinder of the plurality of cylinders, compute an average of the maximum gas pressures for each active cylinder, determine an optimal pressure for each deactivated cylinder of the plurality of cylinders responsive to the computed gas pressures, and manage the pressure control valve in each of the deactivated cylinders to achieve the optimal pressure. The pressure control valve includes one of an intake valve, an exhaust valve, and combinations thereof. Optionally, the optimal pressure includes one-half of the average of the maximum gas pressures for each active cylinder. The optimal pressure includes a value that is determined through one of measurement and simulation. The pressure control valve on each of the deactivated cylinders is configured to open when a piston is at bottom dead center. The opening of the pressure control valve is operable to equalize gas pressure in the deactivated cylinder with a port, wherein the port includes one of an intake port and an exhaust port. The optimal pressure provides torque oscillations from the deactivated cylinder that is out of phase with the torque oscillations from the active cylinder, and the torque oscillations from each of the deactivated cylinders and the torque oscillations from each of the active cylinders cancels each other out thereby reducing torsional vibrations.

In yet another exemplary embodiment of the present disclosure, a closed control loop method to control torsional vibrations in a V8 engine with variable displacement due to cylinder deactivation includes measuring gas pressure in a plurality of active and deactivated cylinders, determining the maximum gas pressure value for an engine cycle for each of the plurality of active cylinders, averaging the maximum gas pressure value for each of the plurality of active cylinders, dividing the average by one-half to obtain a target pressure for each of the plurality of deactivated cylinders, comparing the target pressure to the measured gas pressure for each of the deactivated cylinders, adjusting the phase of a pressure control value for each of the plurality of deactivated cylinders responsive to the comparing step, and opening the pressure control valve for each of the plurality of deactivated cylinders when a piston is at bottom dead center. The closed control loop is repeated while an engine is in cylinder deactivation mode.

### BRIEF DESCRIPTION OF THE DRAWINGS

The present disclosure is illustrated and described herein with, reference to the various drawings, in which like reference numbers denote like system, components and/or method steps, respectively, and in which:

FIG. 1 is a sectional view of an engine block illustrating one cylinder bore formed in the engine block;

FIG. 2 is a graph illustrating how the pressure in a deactivated cylinder is controlled;

FIG. 3 is a flowchart of a closed control loop for controlling pressure in deactivated cylinders according to an exemplary embodiment of the present disclosure;

FIG. 4 is a block diagram illustrating an Electronic Control Unit (ECU) configured to operate the closed control loop of FIG. 3, according to an exemplary embodiment of the present disclosure;

FIG. 5 is a graph illustrating minimized torque fluctuations by maintaining the optimum pressure in the deactivated cylinders according to an exemplary embodiment of the present disclosure;

FIG. 6 is a graph illustrating the calculated engine output torque due to gas pressure for an exemplary VS engine operating in cylinder deactivation mode;

FIG. 7 is a graph illustrating an example of the frequency content of the engine output torque for an uncontrolled vibration and a controlled vibration utilizing the algorithms presented herein;

FIG. 8 is a graph illustrating a simulation of a VS engine with variable displacement showing angular displacement as a function of crankshaft angle in degrees; and

FIG. 9 is a graph illustrating the frequency content of the vibration due to variable displacement.

### DETAILED DESCRIPTION OF THE DISCLOSURE

In various exemplary embodiments, the present disclosure utilizes deactivated cylinders in a variable displacement engine to control the torsional vibration of a crankshaft. In a deactivated mode, deactivated cylinders are compressed and expanded by a reciprocating piston, but they are doing no net work and still causing an oscillating torque on the crankshaft. The present disclosure utilizes this oscillating-torque to counter torque from the active cylinders by controlling the gas pressure in the deactivated cylinders. For example, intake and exhaust values can be used to equalize the pressure between the cylinder and ports. The present disclosure computes an optimum gas pressure in deactivated cylinders to minimize total torque fluctuations. This optimum pressure is determined for the specific engine type through either measurement or simulation. For example, a V8 variable displacement engine has an optimum gas pressure that is approximately one-half that of the active cylinders for V8 variable displacement engines.

The present disclosure utilizes an Electronic Control Unit (ECU) or the like in combination with pressure sensors in all cylinders, i.e. active and deactivated cylinders. The pressure sensors report pressure measurements, and the ECU calculates an optimal pressure for the deactivated cylinders based on averages from the active cylinders. Accordingly, the ECU can control intake and exhaust valves in the deactivated cylinders to equalize the pressure to the optimal level. The present disclosure utilizes an engine's management system to operate a control loop to control pressure in deactivated cylinders to minimize the overall torsional vibrations. Advantageously, the systems and methods of the present disclosure are effective at all engine speeds and can be turned on/off without affecting engine operation. Additionally, the present disclosure eliminates the need for flywheels or dampers to control vibrations, and provides better durability and packaging issues.

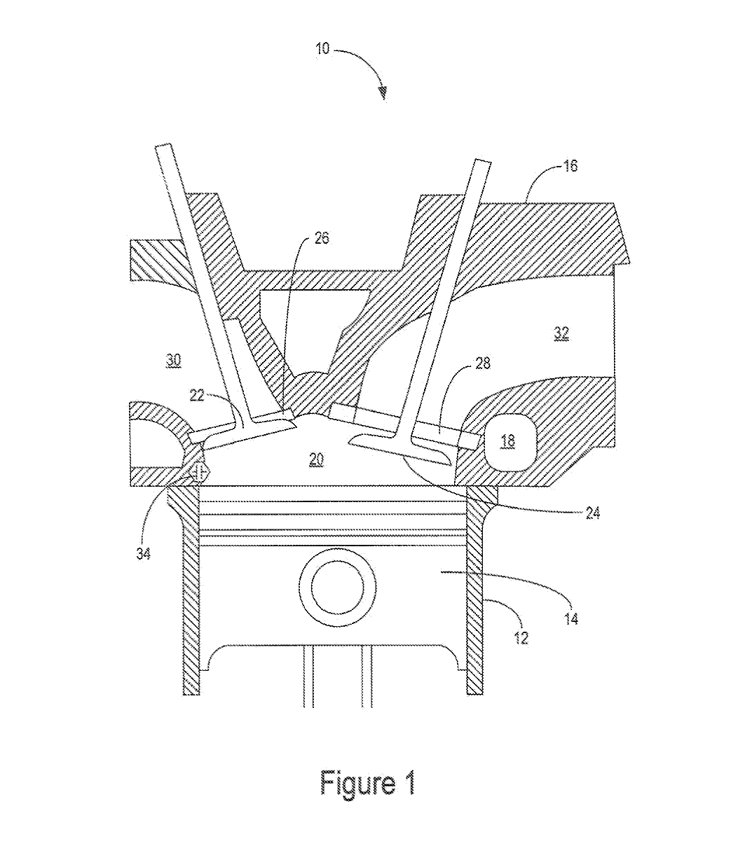

Referring to FIG. 1, a sectional view of an engine block 10 illustrates one cylinder bore 12 formed in the engine block 10. The cylinder bore 12 partially defines a combustion chamber 20 along with a piston 14 which reciprocates in the cylinder bore 12. At the upper portion of the engine block 10, a cylinder head 16 closes the cylinder bore 12. The cylinder head 16 includes a coolant passage 18. An exhaust port 30 enables the selective discharge of exhaust gasses from the combustion chamber 20. An exhaust valve 22 controls the selective flow of exhaust, gasses cooperative with a valve seat 26 through the exhaust port 30. An intake port 32 selectively supplies a flow of air and fuel into the combustion chamber 20. A valve seat 28 cooperative with an intake valve 24 controls the selective flow of air and fuel through a downstream opening of the intake port 32.

While in a deactivated mode in a VDS engine, the gas in the deactivated combustion chamber 20 will be compressed and expanded by the piston 14 which is reciprocating despite doing no work. This causes oscillating torque on a crankshaft (not shown) that can be used to counter torque from active cylinder bores 12. For example, the optimum maximum gas pressure in deactivated cylinders to minimize the total torque fluctuations is approximately one half of that in the active cylinders of a VS variable displacement engine. For other types of engines, the optimum maximum gas pressure can be determined beforehand though measurements or simulations. The present disclosure utilizes infinitely variable valve timing and the lift mechanism for the exhaust and intake valves 22 and 24 to control gas pressure in the deactivated cylinders to minimize torsional vibrations.

Additionally, cylinder pressure sensors 34 are included in the cylinder bore 12. These sensors 34 are configured to provide pressure measurements to an electronic control unit (ECU). The ECU, also known as an Engine Control Module (ECM) or Powertrain Control Unit/Module (PCU, PCM) if it controls both an engine and a transmission, is an electronic control unit which controls various aspects of an internal combustion engine's operation. Typically, ECU's control the quantity of fuel injected into each cylinder bore 12 each engine cycle, the ignition timing. Variable Valve Timing (VVT), the level of boost maintained by the turbocharger (in turbocharged cars), and control other peripherals. ECUs can determine the quantity of fuel, ignition timing and other parameters by monitoring the engine through sensors, such as the pressure sensors 34. Other sensors can include, manifold absolute pressure sensor (MAP) sensor, throttle position sensor, air temperature sensor, oxygen sensor, and the like.

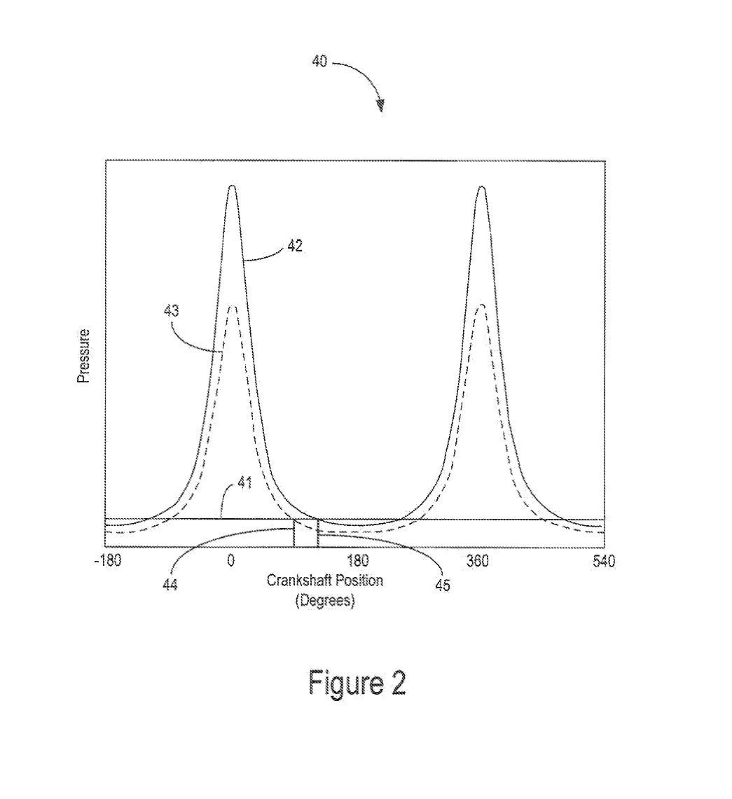

Referring to FIG. 2, in an exemplary embodiment of the present disclosure, the exhaust and intake valves 22 and 24 are utilized as pressure control valves to equalize the pressure between the cylinder and the exhaust or intake ports 30 and 32. The phase angle at which this equalization occurs affects the maximum cylinder pressure in deactivated mode. A graph 40 describes how the pressure in a deactivated cylinder is controlled. The graph 40 illustrates pressure as a function of the crankshaft position in degrees for port pressure 41, high pressure 42, and low pressure 43. The piston 14 is at top dead center (TDC), resulting in minimum cylinder volume and highest pressure, at a crank angle of 0 and again at 360 degrees. While the cylinder is in deactivated mode, the gas trapped in the cylinder is compressed and expanded with each piston stroke.

The port pressure 41 is relatively constant over each piston stroke. The high and low pressure 42 and 43 illustrate the pressure relationship versus crankshaft position for a relatively higher and lower pressure scenario in the cylinder bore 12. The pressure-volume relationship of the gas in the cylinder bore 12 can be described by the polytropic equation for ideal gases:

pv^{k}=C (1)

where p is the pressure, v is volume, k is any real number (polytropic exponent), and C is a constant.

In an exemplary embodiment of the present disclosure, the pressure control valve (i.e., the exhaust or intake valve 22 and 24) will be opened briefly while the piston 14 is near bottom dead center (BDC) at each crankshaft revolution. This equalizes the pressure between the cylinder bore 12 and the attached port 30 and 32. The maximum cylinder pressure occurs, if the valve opening occurs while the piston is at 180 degrees, or BDC, i.e., when the crankshaft is at valve phase 44 and 45 for low and high pressure 42 and 43, respectively. If the valve 22 and 24 opening occurs before the piston reaches BDC, the gas in the cylinder, now at external port pressure, will first be expanded before being compressed. The maximum cylinder pressure will be lower in this case than if the valve event occurred at BDC. Accordingly, the pressure control valves (i.e., the exhaust or intake valve 22 and 24) can equalize the pressure between the cylinder bore 12 and the ports 30 and 32 by opening at the respective valve phases 44 and 45.

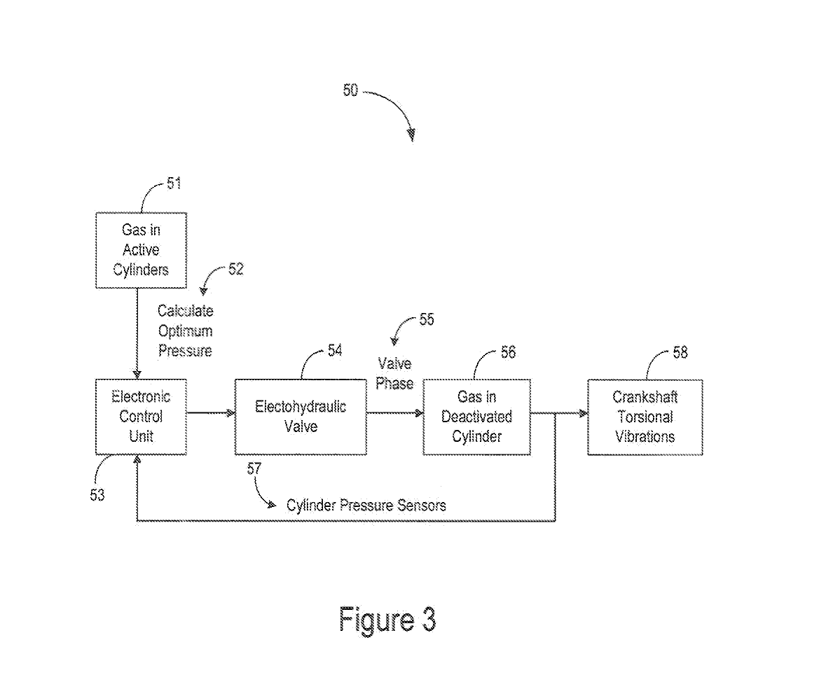

Referring to FIG. 3, a closed control loop 50 is illustrated according to an exemplary embodiment of the present disclosure. As described herein, the cylinder pressure in each cylinder is continuously measured by a cylinder pressure sensor 34 or the like. The closed control loop 50 is utilized during each engine cycle, as determined by a crank, position sensor, to calculate an optimum pressure value for the deactivated cylinders based upon pressure measurements from the active cylinders, and to adjust the deactivated cylinder pressure accordingly.

First, measurements are taken of the gas pressure in the active cylinders during each engine-cycle (step 51). The resulting value for each of the active cylinders is averaged, and half of the averaged, value is used to calculate an optimum pressure for the deactivated cylinders (step 52). Taking one-half of the averaged value is for a V8 variable displacement engines. This value will differ for other types of engines (e.g., V6), and can be determined through measurements or simulation. The measurements taken in step 51 are provided to an ECU and the ECU can perform the optimum pressure calculation of step 52 (step 53). The ECU is in communication with sensors from each of the cylinders and with the intake and exhaust valves 22 and 24. The intake and exhaust valves 22 and 24 can be electro-hydraulic valves which can be controlled by the ECU (step 54).

In the closed control loop 50, the ECU receives measurements from the gas pressure in deactivated cylinders (step 56) from the cylinder pressure sensors (step 57) and compares these values to the calculated optimum pressure. If the pressure in the deactivated cylinders is higher than the desired pressure then the valve phase (step 55) on the pressure control valve is moved farther away from bottom dead center, and conversely, if the pressure is too low then the valve phase is moved close to bottom dead center (step 57). The purpose of controlling the pressure in the deactivated cylinders is to reduce crankshaft torsional vibrations (step 58).

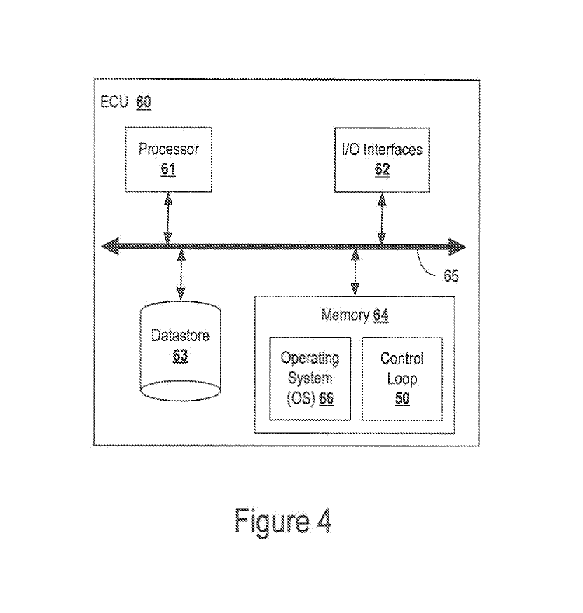

Referring to FIG. 4, a block diagram illustrates an ECU 60 configured to operate the closed control loop 50, according to an exemplary embodiment of the present disclosure. The ECU 60 can be a digital computer that, in terms of hardware architecture, generally includes a processor 61, input/output (I/O) interfaces 62, a data store 63, and memory 64. The components (61, 62, 63, and 64) are communicatively coupled via a local interface 65. The local interface 65 can be, for example, one or more buses or other wired or wireless connections, as is known in the art. The local interface 65 can have additional elements, which are omitted for simplicity, such as controllers, buffers (caches), drivers, repeaters, and receivers, among many others, to enable communications. Further, the local interface 65 can include address, control and/or data connections to enable appropriate communications among the aforementioned components.

The processor 61 is a hardware device for executing software instructions. The processor 61 can be any custom made or commercially available processor, a central processing unit (CPU), an auxiliary processor among several processors associated with the ECU 60, a semiconductor-based microprocessor (in the form of a microchip or chip set), or generally any device for executing software instructions. When the ECU 60 is in operation, the processor 61 is configured to execute software stored within the memory 64, to communicate data to and from the memory 64, and to generally control operations of the ECU 60 pursuant to the software instructions.

The I/O interlaces 62 are used to receive input from and/or for providing system output, to one or more devices or components, such as cylinder pressure sensors, intake and exhaust valve control, MAP sensor, throttle position sensor, air temperature sensor, oxygen sensor, and the like. I/O interfaces 62 can include, for example, a serial port, a parallel port, a small computer system interface (SCSI), a Controller Area Network bus (CANbus), a universal serial bus (USB) interface, and any other connection type as is known in the art.

The data store 63 can be used to store information received from the I/O interfaces 62. The data store can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the data store may incorporate electronic, magnetic, optical, and/or other types of storage media.

The memory 64 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 64 may incorporate electronic, magnetic, optical, and/or other types of storage media. Note that the memory 64 can have a distributed architecture, where various components are situated remotely from one another, but can be accessed by the processor 61.

The software in memory 64 can include one or more software programs, each of which includes an ordered listing of executable instructions for implementing logical functions. In the example of FIG. 4, the software in the memory system 64 includes the closed control loop 50 and a suitable operating system (O/S) 66. The operating system 66 essentially controls the execution of other computer programs, such as the closed control loop 50 and other functions related to various aspects of an engine's operation, and provides scheduling, input-output control, file and data management, memory management, and communication control and related services.

The ECU 600 is configured, to operate the closed control loop 50 by receiving inputs through, the I/O interfaces 62 from, the pressure sensors, calculating optimum pressure based on the algorithms described herein, and communicating appropriate actions to intake and exhaust valves responsive to the optimum pressure and received readings from the pressure sensors. Advantageously, the present disclosure can operate on an existing ECU 600 in vehicles with the addition of software code to operate the closed control loop 50, and a communication link to the pressure sensors.

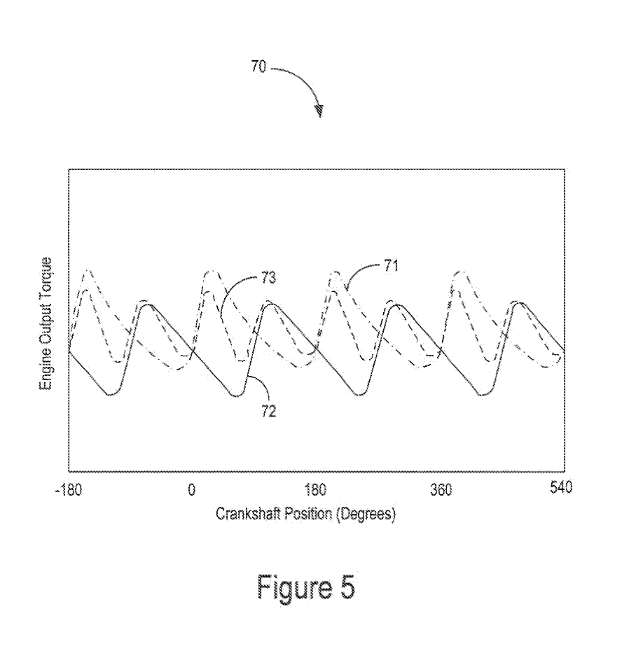

Referring to FIG. 5, a graph 70 illustrates minimized torque fluctuations by maintaining the optimum pressure in the deactivated cylinders according to an exemplary embodiment of the present disclosure. Graph 70 shows engine output torque as a function of crankshaft position in degrees for active cylinders 71, deactivated cylinders 72, and engine total 73 for all cylinders.

When a V8 engine with VDS is operating in 4-cylinder mode, the torque 71 from the active cylinders is mainly 2^{nd} order (i.e., two vibration periods for every crankshaft revolution). The torque 72 from the deactivated cylinders is also 2^{nd} order, hut out of phase with the torque 71 from the active cylinders. If the magnitude of the torque 71 and 72: from the active and deactivated cylinders are the same magnitude, then the 2^{nd} order torque will be cancelled. The optimum maximum cylinder pressure in the deactivated cylinders is half of the maximum pressure in the active cylinders for a V8 variable displacement engine. This is because the maximum pressure occurs in two of the deactivated cylinders at the same time. The combined torque 72 from the deactivated cylinder is used to counterbalance the torque 71 from the active cylinder resulting in the reduced overall torque 73. Note, the optimum maximum cylinder pressure for other engine types (e.g. V6 variable displacement or the like) can be determined through measurements or simulations.

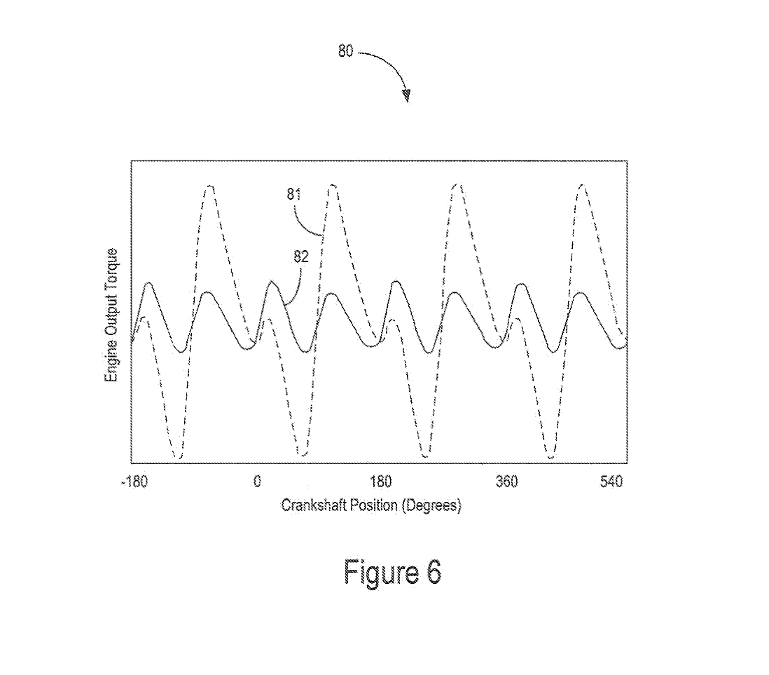

Referring to FIG. 6, a graph 80 illustrates the calculated engine output torque due to gas pressure for an exemplary V8 engine operating in cylinder deactivation mode. The graph 80 plots engine output torque as a function of crankshaft position in degrees showing an uncontrolled vibration 81 and a controlled vibration 82 utilizing the algorithms present herein. As described herein, in a V4 mode (i.e., a V8 VDS engine with half of the cylinders deactivated), the output torque will vary depending on the pressure in the deactivated cylinders. The present disclosure utilizes a control loop to keep the cylinder pressure in the deactivated cylinders at the optimum level to minimize vibrations. As shown in graph 80, the controlled vibration 82 has significantly reduced vibrations from the uncontrolled vibration 81.

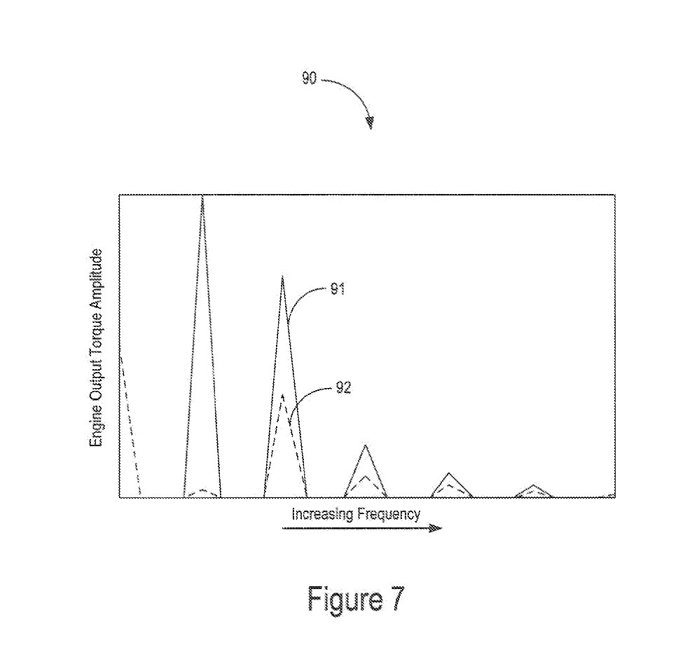

Referring to FIG. 7, a graph 90 illustrates an example of the frequency content of the engine output torque for an uncontrolled vibration 91 and a controlled vibration 92 utilizing the algorithms presented herein. The graph 90 illustrates engine output torque frequency amplitude as a function of increasing frequency. The uncontrolled vibration 91 does not utilize the control loop described herein, and accordingly shows higher frequency content resulting in increased torsional vibration. The controlled vibration 92 shows significantly lower amplitude of the frequency content, leading to reduced torsional vibrations.

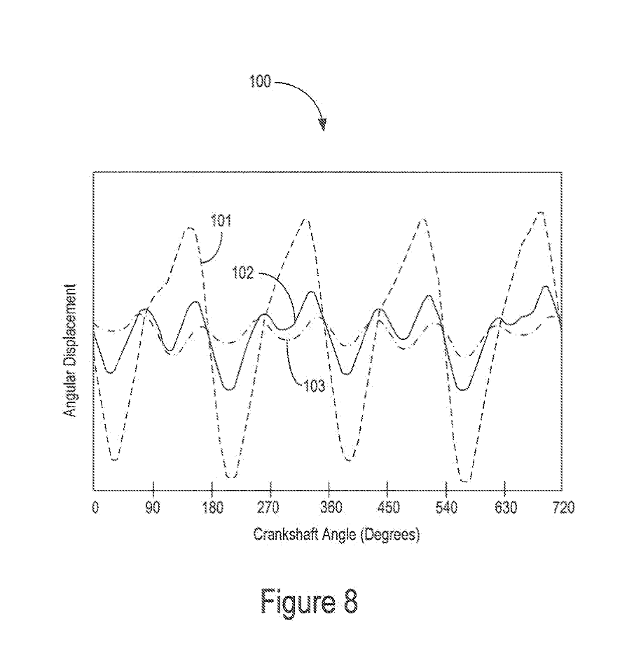

Referring to FIG. 8, a graph 100 illustrates a simulation of a V8 engine with variable displacement showing angular displacement as a function of crankshaft angle in degrees. The graph 100 includes a plot for a V4 mode 101 without using the algorithms presented herein, a V4 mode 102 using fee algorithms presented herein, and a VS mode 103. In the V8 mode 103, the engine is not utilizing variable displacement and accordingly the angular displacement is low relative to the V4 modes 101 and 102. In the V4 modes 101 and 102, the torsional vibrations can be much greater than the vibrations in the V8 mode 103, depending on the pressure in the deactivated cylinders. Without the algorithms presented herein, the V4 mode 101 shows significant variance in angular displacement leading to higher torsional vibration. The V4 mode 102 utilizing the algorithms presented herein significantly reduces angular displacement over varying crankshaft angles.

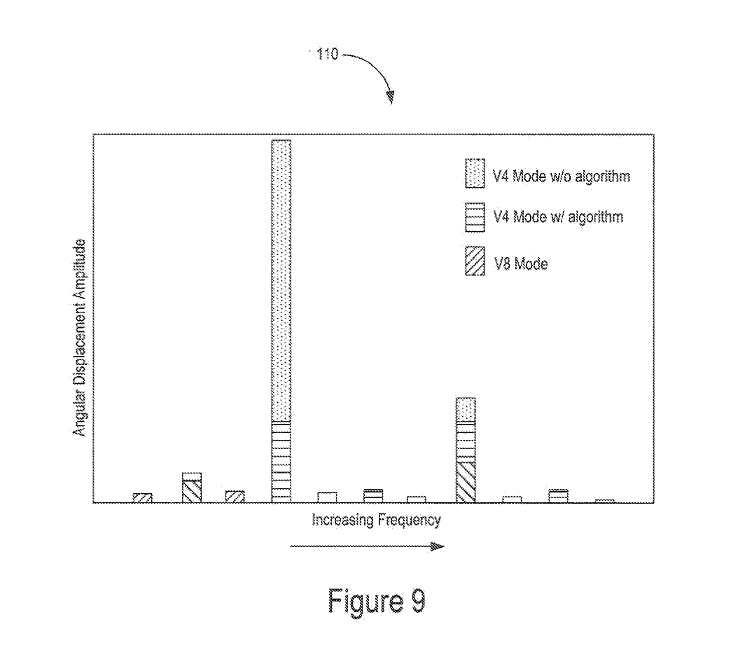

Referring to FIG. 9, a graph 110 illustrates the frequency content of the vibration due to variable displacement. The graph 110 shows angular displacement frequency amplitude as a function of increasing frequency for a V4 mode wife and without the algorithms presented herein and for a V8 mode. As shown in graph 110, in the V4 mode, the amplitude is much greater than in the V8 mode (i.e., greater amplitude when variable displacement is operating). Also, the dominant frequency is lower in the V4 modes than in the V8 mode. However, the algorithms presented herein show a reduction in fee low frequency contribution due to variable displacement.

Although the present disclosure has been illustrated and described herein with reference to preferred embodiments and specific examples thereof, it will be readily apparent to those of ordinary skill in the art feat other embodiments and examples may perform similar functions and/or achieve like results. All such equivalent embodiments and examples are within the spirit and scope of the present disclosure and are intended to be covered by the following claims.

What is claimed is:

1. A method to control torsional vibrations due to cylinder deactivation, comprising:
measuring gas pressure in an active and a deactivated cylinder;
determining a target pressure for the deactivated cylinder responsive to the measured gas pressure in the active cylinder; and
adjusting a phase on a pressure control valve of the deactivated cylinder responsive to a difference between the measured gas pressure in the deactivated cylinder and the determined target pressure for the deactivated cylinder.

2. The method to control torsional vibrations of claim 1, wherein the measuring step is performed by a cylinder pressure sensor.

3. The method to control torsional vibrations of claim 1, wherein the target pressure comprises a value that is approximately one-half of the measured gas pressure in the active cylinder.

4. The method to control torsional vibrations of claim 1, wherein the target pressure comprises a value that is determined through one of measurement and simulation.

5. The method to control torsional vibrations of claim 1, wherein the adjusting step comprises:
if the measured gas pressure in the deactivated, cylinder is higher than the target pressure, moving the pressure control, valve phase away from bottom dead center; and
if the measured gas pressure in the deactivate cylinder is lower than the target pressure, moving the pressure, control valve phase closer to bottom dead, center.

6. The method to control torsional vibrations of claim 1, wherein pressure control valves comprise one of an intake valve, an exhaust valve, and combinations thereof.

7. The method to control torsional vibrations of claim 1, further comprising:
opening the pressure control valve when a piston is at bottom dead center;
wherein the adjusting phase step is operable to adjust the opening of the pressure control valve in order to equalize gas pressure in the deactivated cylinder.

8. The method to control torsional vibrations of claim 1, wherein the target pressure provides torque oscillations from the deactivated cylinder that is out of phase with the torque oscillations from the active cylinder; and
wherein the torque oscillations from the deactivated cylinder and the torque oscillations from the active cylinder cancel each other out thereby reducing torsional vibrations.

9. The method to control torsional vibrations of claim 1, wherein the adjusting step and determining steps are performed by an electronic control unit;
wherein the measuring step is performed by a cylinder pressure sensor;
wherein the cylinder pressure sensor communicates measured gas pressure to the electronic control unit; and
wherein the electronic control unit operates the pressure control valve to achieve the target pressure in the deactivated cylinder.

10. A torsional vibration control system for engine configured with cylinder deactivation, comprising:
a plurality of cylinders each comprising a cylinder pressure sensor and a pressure control valve, wherein the cylinder pressure sensor is configured to measure gas pressure in the cylinder; and
an electronic control unit in communication with each of the cylinder pressure sensors in the plurality of cylinders, wherein the electronic control unit is configured to:
receive gas pressure measurements for each of the plurality of cylinders;
determine a maximum gas pressure for each active cylinder of the plurality of cylinders;
compute an average of the maximum gas pressures for each active cylinder;
determine an optimal pressure for each deactivated cylinder of the plurality of cylinders responsive to the computed gas pressures; and
manage the pressure control valve in each of the deactivated cylinders to achieve the optimal pressure.

11. The torsional vibration control system of claim 10, wherein the pressure control valve comprises one of an intake valve, an exhaust valve, and combinations thereof.

12. The torsional vibration control system of claim 10, wherein the optimal pressure comprises one-half of the average of the maximum gas pressures for each active cylinder.

13. The torsional vibration control system of claim 10, wherein the optimal pressure comprises a value that is determined through one of measurement and simulation.

14. The torsional vibration control system of claim 10, wherein the pressure control valve on each of the deactivated cylinders is configured, to open when a piston is at bottom dead center.

15. The torsional vibration control system of claim 13, wherein the opening of the pressure control valve is operable to equalize gas pressure in the deactivated cylinder with a port, wherein the port comprises one of an intake port and an exhaust port.

16. The torsional vibration control system of claim 10, wherein the optimal pressure provides torque oscillations from the deactivated cylinder that is out of phase with the torque oscillations from the active cylinder; and
wherein the torque oscillations from each of the deactivated cylinders and the torque oscillations from each of the active cylinders cancels each other out thereby reducing torsional vibrations.

17. A closed control loop method to control torsional vibrations in a V8 engine with variable displacement due to cylinder deactivation, comprising:
measuring gas pressure in a plurality of active and deactivated cylinders;
determining the maximum gas pressure value for an engine cycle for each of the plurality of active cylinders;
averaging the maximum gas pressure value for each of the plurality of active cylinders;
dividing the average by one-half to obtain a target pressure for each of the plurality of deactivated cylinders;
comparing the target pressure to the measured gas pressure for each of the deactivated cylinders;
adjusting the phase of a pressure control value for each of the plurality of deactivated cylinders responsive to the comparing step; and
opening the pressure control valve for each of the plurality of deactivated cylinders when a piston is at bottom dead center.

18. The closed control loop method to control torsional vibrations of claim 17, wherein the closed control loop is repeated while an engine is in cylinder deactivation mode.
